(19) United States
(12) Patent Application Publication
(10) Pub. No.: US 2022/0402167 A1
(43) Pub. Date: Dec. 22, 2022

(54) SKID-MOUNTED CONCRETE PRODUCTION SYSTEM AND METHOD

(71) Applicant: Telly Walsworth, Spanish Fort, AL (US)

(72) Inventor: Telly Walsworth, Spanish Fort, AL (US)

(21) Appl. No.: 17/416,366

(22) PCT Filed: Jul. 28, 2020
(86) PCT No.: PCT/US2020/043906

§ 371 Date: Jun. 18, 2021

Related U.S. Application Data
(60) Provisional application No. 62/987,269, filed on Mar. 9, 2020.

(51) Int. Cl. B28C 9/04; B28C 7/00

(52) U.S. Cl. CPC B28C 9/0463; B28C 7/00

(57) ABSTRACT

A portable skid-mounted concrete production system includes individual units for the production of concrete that are each mounted on a portable skid, which may be individually transported on cargo trucks to construction sites for on-site concrete production. The skids can be offloaded at a construction site and then supply lines for inputting various ingredients into the concrete mix may be connected between the skid units, as well as electrical power lines for providing power to equipment within the system. The system may be set up on-site to begin continuous production of concrete within hours of offloading the skids.

### CROSS REFERENCES

This application is a U.S. National Stage application of PCT Application Number PCT/US20/43906, filed on Jul. 28, 2020, which claims the benefit of U.S. Provisional Application No. 62/987,269, filed on Mar. 9, 2020, which application is incorporated herein in its entirety by reference.

### FIELD OF THE DISCLOSURE

The subject matter of the present disclosure refers generally to a portable skid-mounted concrete production system and a method of using the system to produce concrete.

### BACKGROUND

The production of concrete for construction generally involves the process of mixing together various ingredients to produce the concrete and then letting the concrete cure, or harden, to produce the finished product. The ingredients generally include aggregate, such as sand and gravel, cement, water, and various admixture chemicals, depending on the particular application. Commercial concrete production typically occurs in a concrete plant, which is typically a very large industrial facility. Commercial concrete plants are often referred to as batch plants because the concrete produced in such facilities is produced in large batches. Concrete plants may be dry mix concrete plants or wet mix concrete plants, depending on whether water is added to the concrete mix on-site at the plant. In either case, the resulting concrete mix is typically loaded onto trucks for transport of the concrete mix to a construction site for final placement.

Concrete plants generally include numerous pieces of large equipment required for the production of concrete. For instance, concrete plants have large storage hoppers to store various ingredients, such as the aggregate and cement, a large mixer for mixing all of the ingredients, cement batchers, aggregate batchers, and conveyors. Large concrete plants are generally capable of efficiently producing large quantities of high-quality concrete. However, there are drawbacks to large, stationary concrete plants. For instance, it can be difficult, inconvenient, and expensive to transport batches of concrete on concrete mixer trucks to remote locations far from the concrete plant. In some cases, mobile concrete plants have been utilized at remote construction sites to produce concrete on-site to overcome some of the disadvantages of large, stationary plants. However, moving such a mobile plant from one construction job to another and then setting up the mobile plant at the new site is generally an expensive and time-consuming process, which may increase the cost of the concrete produced. Mobile plants also generally do not produce concrete of the same quality as stationary plants.

Accordingly, there is a need in the art for an improved mobile concrete plant that can be transported and set up quickly and inexpensively to produce high-quality concrete on-site at any construction site.

### SUMMARY

A portable skid-mounted concrete production system and a method of using the system to produce concrete are provided. The system comprises a plurality of skid-mounted units that may be individually transported to any construction site where the individual units can be placed in close proximity to each other on-site and then be operatively connected to each other to produce concrete on-site. Once placed on-site, connections between the individual skid-mounted units may be installed quickly and easily so that the mobile concrete plant can begin producing concrete on-site within a period of hours after transporting the skid units to the site. Thus, the present concrete production system functions as a modular system that facilitates both transporting of the individual units and connecting the individual units to begin concrete production. Each unit is skid-mounted and sized such that the unit may be individually transported to the construction site on a standard semi-trailer hauled by a tractor unit or similar type of cargo truck or, alternatively, on a rail car. The skids are each preferably 25-foot long by 8-foot wide skids for transport on a standard cargo truck.

The portable skid-mounted production system comprises a concrete mixing unit, a power supply unit, a water supply unit, and a portable cement silo. The concrete mixing unit comprises a concrete mixer mounted on a first portable skid and having inputs for water, cement, and aggregate, as well as an auger that conveys wet concrete slurry from the mixer to a discharge point. The power supply unit comprises a generator for supplying power to the other skid units and is mounted on a second portable skid. The generator and other components of the power supply unit, which preferably includes a control room, are preferably contained within an enclosed structure that is mounted on the second skid. The water supply unit comprises a water tank mounted on a third portable skid for supplying water to the concrete mixer. The water tank is preferably a shipping container tank mounted on the third skid. The portable cement silo supplies cement to the concrete mixer and is preferably a horizontal cement silo mounted on a trailer that may be towed by a truck for transportation to the construction site as a unit separate from the portable skid units. This type of cement silo is commonly used in the industry and often referred to as a “cement pig.” The concrete mixing unit preferably additionally includes a motor that powers the concrete mixer, at least two aggregate bins, which may preferably be used for sand and gravel, and a cement bin. The concrete mixing unit may also include an admixture storage tank and pump for supplying admixture chemicals to the concrete mixer.

Once the individual skid units have been transported to a construction site, the units may be operatively connected to each other to collectively operate as a concrete production system. First, the power supply unit is operatively connected to the concrete mixing unit, to the water supply unit, and to the portable cement silo such that the generator supplies power to the concrete mixing unit, to the water supply unit, and to the portable cement silo. Electrical power cords may be utilized to connect the generator of the power supply unit to the other units and to the cement silo. The power supply unit may supply power to the concrete mixing unit to power an electric motor that powers the concrete mixer, a conveyor belt for conveying aggregate into the mixer, and a dry cement auger for metering cement into the mixer, as well as a pump for supplying admixture chemicals into the mixer. Additionally, the power supply unit may supply power to a water pump on the water supply unit for supplying water to the concrete mixer and to a blower on the cement silo for supplying cement into the mixer. The generator may also supply power to control systems for controlling operation of the concrete production system, lighting on all of the skid units and cement silo, and any other auxiliary systems requiring electrical power. The wet concrete slurry auger is preferably detachable by quick connect fittings so that the auger may be detached from the concrete mixing unit for transport. Next, a water supply line is connected to the water tank of the water supply unit and to the concrete mixer of the concrete mixing unit for supplying water to the concrete mixer. Finally, a cement supply line is connected to the cement silo and to the concrete mixer for supplying cement to the concrete mixer.

Once the skid units are set in place and operatively connected to each other, the water, cement, and aggregate may be continuously and homogenously mixed in the concrete mixer to form the wet concrete slurry. The wet concrete slurry may then be continuously discharged by the auger as needed at a discharge point. The concrete slurry may be discharged to a concrete mixer truck for pouring the concrete as needed. Thus, the present system may be operated as a continuous concrete production system rather than a batch system. The system may be operated by two workers. One worker may be stationed in the control room of the power supply unit to constantly monitor the operation and make any adjustments as needed. A second worker may operate a front-end loader to load aggregate, which may include sand and gravel, into respective aggregate bins in order to maintain a continuous supply of aggregate to the mixer. Once set up, the system may preferably produce up to 80 cubic yards of high-quality concrete per hour. The system does not require settling ponds and generally also does not require height permits because the individual units are constructed within legal height limits, as well as within load limits for road transport.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 shows a schematic view of a skid-mounted concrete production system in accordance with the present disclosure.

FIG. 2 shows a side view of a skid-mounted concrete mixing unit for a concrete production system in accordance with the present disclosure.

FIG. 3A shows a side view of a skid-mounted power supply unit for a concrete production system in accordance with the present disclosure.

FIG. 3B shows a side view of a skid-mounted power supply unit for a concrete production system in accordance with the present disclosure.

FIG. 4 shows a side view of a skid-mounted water supply unit for a concrete production system in accordance with the present disclosure.

FIG. 5 shows a front view of a skid-mounted concrete production system in accordance with the present disclosure.

FIG. 6A shows a schematic view of a skid-mounted concrete production system including a cement hopper in accordance with the present disclosure.

FIG. 6B shows a schematic view of a skid-mounted concrete production system including two concrete mixing units with cement hoppers in accordance with the present disclosure.

FIG. 6C shows a schematic view of a skid-mounted concrete production system including three concrete mixing units with cement hoppers, two water supply units, and two portable cement silos in accordance with the present disclosure.

FIG. 7 shows a view of a front-end loader being used to load aggregate into bins on a skid-mounted concrete mixing unit in accordance with the present disclosure.

FIG. 8 shows a perspective view of a skid-mounted water supply unit for a concrete production system in accordance with the present disclosure.

FIG. 9 shows a partial view of a skid-mounted water supply unit for a concrete production system, including a wet concrete recycling system for recycling unused concrete slurry, in accordance with the present disclosure.

FIG. 10 shows a partial view of a skid-mounted water supply unit for a concrete production system, including a wet concrete recycling system for recycling unused concrete slurry, in accordance with the present disclosure.

FIG. 11 shows an exploded view of a component of a wet concrete recycling system for recycling unused concrete slurry on a skid-mounted water supply unit in a concrete production system in accordance with the present disclosure.

### DETAILED DESCRIPTION

The present disclosure provides a portable skid-mounted concrete production system and a method of using the system to produce concrete in accordance with the independent claims. Preferred embodiments of the invention are reflected in the dependent claims. The claimed invention can be better understood in view of the embodiments described and illustrated in the present disclosure, viz. in the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

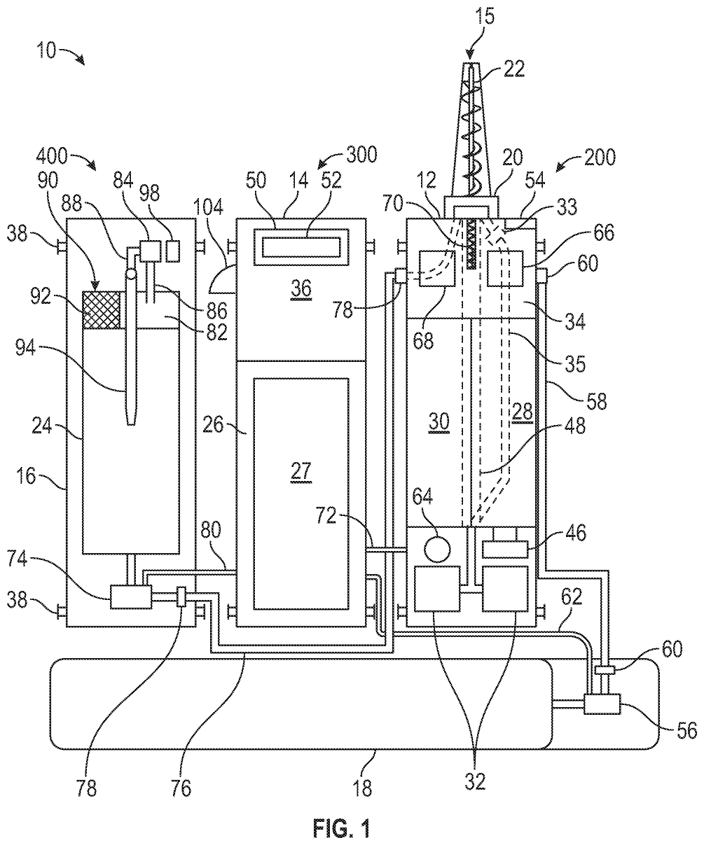

A portable skid-mounted concrete production system 10 and a method of using the system to produce concrete are provided. FIGS. 1-11 illustrate preferred embodiments of the present system 10. The system comprises a plurality of skid-mounted units 200, 300, and 400 that may be individually transported to any construction site where the individual units can be placed in close proximity to each other on-site and then be operatively connected to each other, as best seen in FIG. 1, to produce concrete on-site. Once placed on-site, connections between the individual skid-mounted units 200, 300, 400 may be installed by connecting electrical power lines 62, 72, 80, a water supply line 76, and a cement supply line 58 in the appropriate locations so that the mobile concrete plant 10 can begin producing concrete on-site within a period of hours after transporting the units to the site. Set up typically takes no more than about six to eight hours. Thus, the present concrete production system 10 functions as a modular system in which individual units may be separately transported and connected to each other on-site to begin concrete production. The system may produce concrete continuously rather than in batches. Each unit is skid-mounted and sized such that each unit may be individually transported to the construction site on a standard semi-trailer hauled by a tractor unit or similar type of cargo truck or, alternatively, on a rail car. Each skid unit 200, 300, 400 comprises various components mounted on a portable skid 12, 14, and 16, respectively, and each skid preferably comprises a plurality of attachment points 38 for lifting and transporting the skid units 200, 300, 400. The attachment points 38 may include any type of structure configured for securing cables to the skid for loading and unloading the skid onto and off of a transportation vehicle, such as a truck or other transportation vehicle for transporting the skid unit to a construction site. The skids may be loaded or unloaded by lifting the skid unit or pulling the skid onto a transportation vehicle. The skids 12, 14, 16 are sized to each fit on a standard cargo truck for transportation. Each skid is preferably a 25-foot long by 8-feet wide skid and is preferably constructed using 12-inch treated metal beams. As used herein, the term “skid” or grammatical equivalents thereof refers to any type of generally flat transport structure configured for mounting components of a portable concrete production system on the structure for transport of the skid with components mounted thereon by truck or rail and for use of the skid with mounted components thereon in a process for producing concrete. The components may preferably be permanently mounted on each skid. The skid units 200, 300, 400 may be loaded onto or off of a transportation vehicle by a winch or a crane, such as a 30-ton mobile crane, which is commonly used in the concrete industry, using cables secured to attachment points 38 on each skid 12, 14, 16. One or more of the skids 12, 14, 16 may optionally be mounted on a trailer having wheels for road transportation by truck.

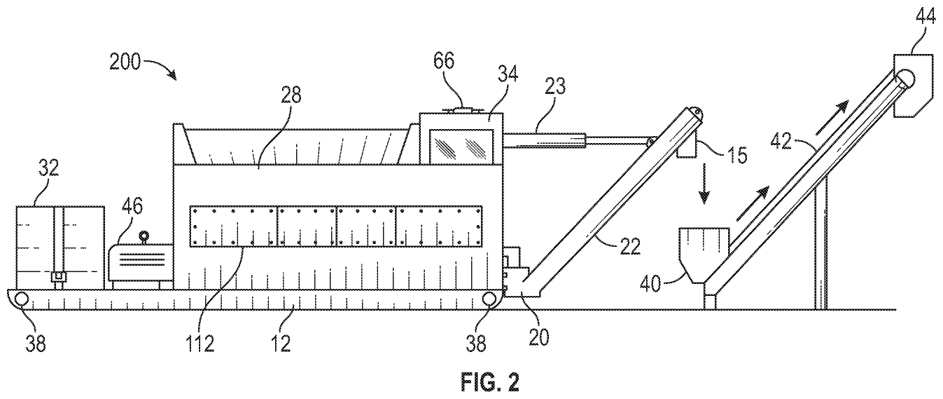

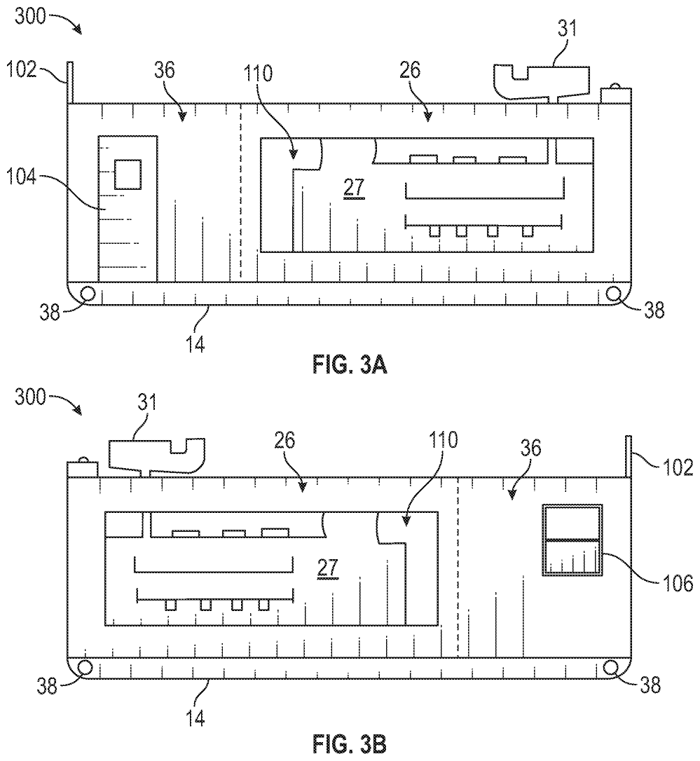

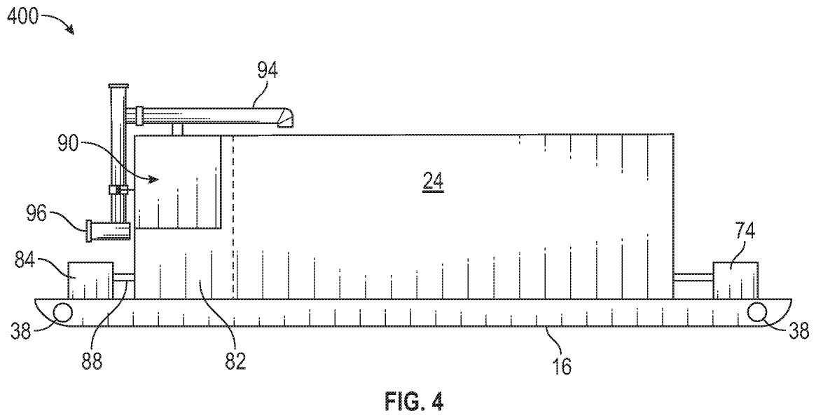

The portable skid-mounted production system comprises a concrete mixing unit 200, a power supply unit 300, a water supply unit 400, and a portable cement silo 18. As shown in FIGS. 1 and 2, the concrete mixing unit 200 comprises a concrete mixer 20 mounted on a first portable skid 12 and having inputs for water 76, cement 58, and aggregate 48, as well as an auger 22 that conveys wet concrete slurry from the mixer 20 to a discharge point 15. The power supply unit 300 is mounted on a second portable skid 14 and comprises a generator 27 for supplying power to the other skid units 200, 400 and to the cement silo 18. The generator 27 and other components of the power supply unit 300, which preferably includes a control room 36, are preferably contained within an enclosed shipping container that is mounted on the second skid 14, as shown in FIGS. 3A and 3B. The water supply unit 400 comprises a water tank 24 mounted on a third portable skid 16 for supplying water to the concrete mixer 20. The water tank 24 is preferably constructed from a modified shipping container tank mounted on the third skid 16, as shown in FIG. 4. The portable cement silo 18 supplies cement to the concrete mixer 20 and is preferably a horizontal cement silo mounted on a trailer that may be towed by a truck for transportation to the construction site as a unit separate from the portable skid units 200, 300, 400. This type of cement silo is commonly used in the industry and is often referred to as a “cement pig.”

FIGS. 1, 2, 5, and 7 illustrate the concrete mixing unit 200 mounted on the first portable skid 12. FIG. 1 generally shows a schematic illustration of how the skid units 200, 300, 400 and the cement silo 18 may be arranged relative to each other in a compact arrangement and operatively connected to each other to operate as a system for producing concrete. As best seen in FIG. 1, the concrete mixing unit 200 comprises a concrete mixer 20 having inputs for water 76, cement 58, and aggregate 48. Water is input into the mixer 20 through a water supply line 76 that conveys water from a water tank 24 on the water supply unit 400 through a water pump 74, which is preferably mounted on the water supply unit 400. Cement is input into the mixer 20 through a cement supply line 58 that conveys cement from the portable cement silo 18 using a blower 56, which is typically pre-mounted on commercially available portable cement silos commonly used in the concrete industry. The cement is preferably first conveyed by the blower 56 into a cement bin 34 mounted on the concrete mixing unit 200. The cement bin 34 functions as a holding compartment from which the cement may then be conveyed from the cement bin 34 into the concrete mixer 20 by a dry cement auger 70, which is preferably a 10-inch auger positioned at a lower end of the cement bin 34. Alternatively, the blower 56 may be used to directly feed cement into the concrete mixer 20. The cement bin 34 preferably has a hatch 66 that provides access to the interior of the cement bin 34. The cement bin 34 preferably holds an amount of cement sufficient to produce at least twenty cubic yards of concrete without the need to refill the bin. The cement bin 34 may optionally by divided into two compartments, one of which may be used to hold fly ash for production of certain types of concrete that include fly ash. The compartment for fly ash preferably also has a hatch 68 for loading fly ash directly into the fly ash compartment. The dry cement auger 70 may be configured for conveying a combination of both dry cement and fly ash into the concrete mixer 20.

The concrete mixing unit 200 further comprises an aggregate bin, and preferably comprises a first aggregate bin 28 for holding sand and a second aggregate bin 30 for holding gravel, though other types of aggregate may be utilized or alternatively only one type of aggregate may be utilized. The concrete mixing unit 200 preferably further comprises a conveyor 48 configured to input aggregate from the aggregate bin into the concrete mixer 20. The conveyor is preferably a conveyor belt 48 positioned below the aggregate bins 28, 30 that feeds the aggregate into the concrete mixer 20. The flow of aggregate may be measured by gates on each respective aggregate bin 28, 30 that open and close to feed a defined amount of aggregate onto the conveyor belt 48 from each aggregate bin 28, 30. Preferably, a single conveyor belt 48 is utilized for conveying both sand and gravel on the belt 48 into the concrete mixer 20, as shown in FIG. 1. The conveyor belt 48 may run below the aggregate bins 28, 30 and the concrete bin 34 and may be positioned below the dry cement auger 70. The rate of input of aggregate may be controlled by controlling the belt 48 speed, and thus scales for the aggregate bins are preferably not required. Alternatively, any similar type of conveying mechanism suitable for feeding aggregate into the mixer 20 from one or more aggregate bins in a controlled manner may be utilized.

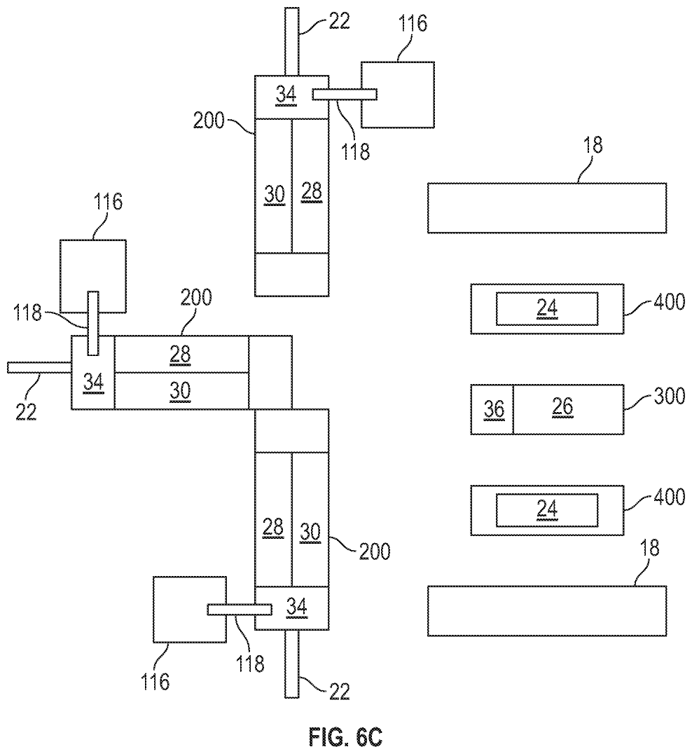

The concrete mixing unit 200 is preferably an open unit with the components attached directly to a skid 12 and not enclosed within any type of structural covering. The aggregate bins 28 and 30 preferably have open tops and have a maximum height of eight feet so that the bins may be loaded with sand, gravel, or other types of aggregate utilizing a front-end loader 100, as illustrated in FIG. 7. Due to the maximum height of the aggregate bins 28, 30, ramps are generally not required for the front-end loader 100 to load aggregate into the bins. The front-end loader 100 may be used to maintain aggregate supply in the aggregate bins 28, 30 during operation of the system 10 to maintain continuous concrete production. The aggregate bins 28, 30 may be constructed as a single structure having a central divider to separate the sand from the gravel or from any other type of aggregate that may be used to produce a particular type of concrete. As seen in FIG. 7, a front-end loader 100 is generally capable of loading aggregate into either of the bins 28 or 30 from one side of the concrete mixing unit 200, as the other side of the unit 200 may not be accessible to the front-end loader 100 due to its proximity to an adjacent unit, such as unit 300 or 400. As shown in FIG. 2, the sides of the aggregate bins 28, 30 may have removable panels 112 for accessing the conveyor belt 48, the dry cement auger 70, or other components of the concrete mixing unit 200.

As shown in FIG. 1, the concrete mixing unit 200 preferably additionally includes at least one admixture storage tank 32, and preferably two admixture storage tanks 32, mounted on the skid 12. As best seen in FIG. 2, the admixture storage tanks 32 may be in the form of removable totes that may be installed and removed as needed. To install the admixture totes 32, each tote may be connected to an admixture supply line 35 that supplies admixture chemicals from the admixture totes 32 to the concrete mixer 20. A pump 33 may be installed on the concrete mixing unit 200 to pump the admixture chemicals into the concrete mixer 20. As shown in FIG. 1, the pump 33 is preferably located in close proximity to the concrete mixer 20. Two admixture totes 32 may be utilized so that an operator of the unit 200 can switch to a second tote when the first is emptied and needs replacement. An optional drum 64 may also be utilized for temporary use of different types of admixture chemicals on an as-needed basis, depending on the type of concrete being produced.

The water, cement, aggregate, and admixture chemicals are all input into the concrete mixer 20 to produce wet concrete slurry. The concrete mixer 20 is preferably a volumetric concrete mixer, which may be adapted for installation on the concrete mixing unit 200 from a commercially available volumetric mixer. As the individual ingredients are pumped or otherwise conveyed into the concrete mixer 20, the auger 22 extends into the mixer 20 and the rotation of the auger 22 mixes the ingredients continuously and homogenously to produce the wet concrete slurry. As the ingredients are continuously input into the concrete mixer 20, the homogenous concrete slurry may then be continuously conveyed and discharged by the auger 22 to a discharge point 15. Thus, the present concrete production system 10 is preferably operated as a continuous production system rather than a batch system. The rate of discharge of concrete slurry may be controlled by adjusting the speed of rotation of the auger 22. The auger 22 is preferably a 12-inch auger that is approximately 13 feet in length. The auger 22 may include an extendable arm 23 to provide adjustment and structural support for the auger 22 when installed. The auger 22 is preferably detachable by a quick connect fitting for installation and removal of the auger 22 from the concrete mixing unit 200 when moving the system between job sites. The extendable arm 23 may be detachable by a hydraulic quick connect fitting.

As shown in FIGS. 1 and 2, the concrete mixing unit 200 preferably includes an electric motor 46 that is powered by the generator 27 on the power supply unit 300. The motor 46 may be used to provide power to the discharge auger 22, the conveyor belt 48, and the dry cement auger 70.

FIG. 2 illustrates a conveyor system that may optionally be utilized with the concrete mixing unit 200 for concrete production. As shown in FIG. 2, the auger 22 may be used to discharge the cement slurry into a hopper or bucket 40 at the lower end of a ramped conveyor belt 42, which may have a bell 44 at the upper end of the conveyor belt 42. The conveyor belt 42 conveys the concrete slurry from the bucket 40 into the bell 44, at which point the concrete slurry may be discharged from the bottom of the bell 44. The conveyor belt 42 and bell 44 may allow for the concrete slurry to be discharged into a hopper or drum mixer on a concrete mixer truck for final placement of the concrete. The bucket 40 preferably holds up to one-third of a cubic yard of concrete slurry. The conveyor belt 42 is preferably a 24-inch wide V-type conveyor belt with ridges to aid in conveying the concrete slurry from the concrete mixer 20 upward to the bell 44. The conveyor belt 42 is preferably powered by a 10-horsepower electric motor, which may be powered by the generator 27 on the power supply unit 300. The structure housing the conveyor belt 42 may be constructed utilizing a 10-inch C-channel set on a flat, stationary bed. The structure preferably has support legs for stability that fold for transport. The conveyor belt 42 and associated structure may be picked up by a front-end loader 100 for transport when moving the system 10 between job sites. The conveyor belt 42 and the auger 22 may both be disassembled and then transported on the same cargo truck as the concrete mixing unit 200 when moving the system between job sites.

FIGS. 1, 3A, 3B, and 5 illustrate the power supply unit 300. The power supply unit 300 is mounted on the second portable skid 14 and comprises an electric generator 27 for supplying power to the other skid units 200, 400 and to the cement silo 18, as well as to electrical components on the power supply unit 300 itself. The generator 27 and other components of the power supply unit 300 are preferably contained within an enclosed structure that is mounted on the second skid 14. The enclosed structure is preferably divided into two separate rooms, which include a motor room 26 that houses the generator 27 and a control room 36 having a control system 50 configured to control various aspects of the concrete production system 10. The generator 27 is preferably a unit including a 200 kW generator driven by a 60-horsepower three-phase diesel motor housed in the motor room 26, as shown in FIGS. 3A and 3B. The generator 27 may be used as a power source to provide electrical power to various components of the system 10, including the blower 56, the water pump 74, the control system 50, the admixture pump 33, the electric motor 46 that powers the discharge auger 22, the aggregate conveyor belt 48, and the dry cement auger 70 of the concrete mixer 20, as well as any other auxiliary systems or equipment requiring electrical power, such as lights 102 located on each skid unit 200, 300, 400 for nighttime operations.

The enclosed structure of the power supply unit 300 is preferably constructed from a 20-foot recycled shipping container mounted on the skid 14 and modified to divide the container into the control room 36 and the motor room 26. As shown in FIGS. 3A and 3B, the shipping container preferably has large windows 110 cut out of the side walls of the container that form the motor room 26 in order to provide access to the generator 27 and to allow air flow through the motor room 26 to provide cooling of the motor. The shipping container may have an exhaust 31 for the motor installed on the roof of the container.

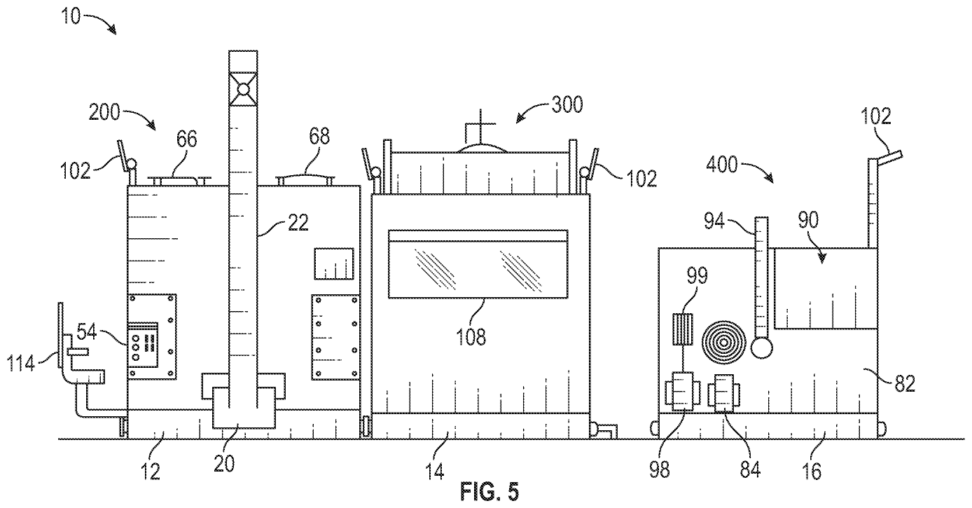

The control room 36 provides a centralized location for an operator of the system 10 to control operation of various pieces of equipment within the system 10. The control room 36 has a door 104 for ingress and egress and preferably has a side window 106 and, as shown in FIG. 5, a large front window 108 to provide the operator with good visibility of the system 10 from inside the control room 36. The control room 36 preferably has insulated walls to minimize noise and to moderate the temperature of the room. The control room 36 optionally has a heating and cooling unit for temperature control, which may be powered by the generator 27 and may be installed on the roof of the shipping container.

The system 10 includes a control system 50 configured to control various aspects of concrete production. The control system 50 includes a control panel 52, which is preferably housed within the control room 36 of the power supply unit 300. The control panel 52 is configured to allow an operator to control electrical power from the generator 27 to all components of the system 10 powered by the generator 27, including the electric motor 46 and the admixture pump 33 on the concrete mixing unit 200, the water pump 74 on the water supply unit 400, and the blower 56 on the cement silo 18. As best seen in FIG. 5, the control system 50 preferably also includes a second control panel 54 located on the concrete mixing unit 200 and configured for controlling operation of the concrete mixer 20. The second control panel 54 may be used by a second operator to control the discharge auger 22, the dry cement auger 70, and the aggregate conveyor belt 48. In addition, the second operator may use the second control panel 54 to control the rate of input of water, cement, aggregate, and admixture chemicals into the concrete mixer 20. The control panel 52 in the control room 36 preferably provides primary control of the system 10, while the second control panel 54 provides secondary control of functions relating to the concrete mixer 20 and relays process information to the control panel 52 in the control room 36. The concrete mixing unit 200 may optionally include a seat 114 attached to the skid 12 for the second operator to use when using the control panel 54 to operate the concrete mixer 20. Any control system suitable for controlling concrete mixing operations may be adapted for use with the present concrete production system 10. The control system 50 may optionally include a wireless remote that allows control of certain system functions remotely by an operator who is not present at the control panel 52 in the control room 36. For instance, an operator outside the control room 36, such as an operator using the front-end loader 100 to load aggregate into the aggregate bins 28, 30, may use the wireless remote for emergency shutdown functions should the operator observe any operational problems requiring immediate shutdown of the system 10. The control system 50 may also optionally include surveillance monitors located at the addition points of the cement, water, and aggregate on the concrete mixing unit 200 for blowout detection for the operator in the control room 36.

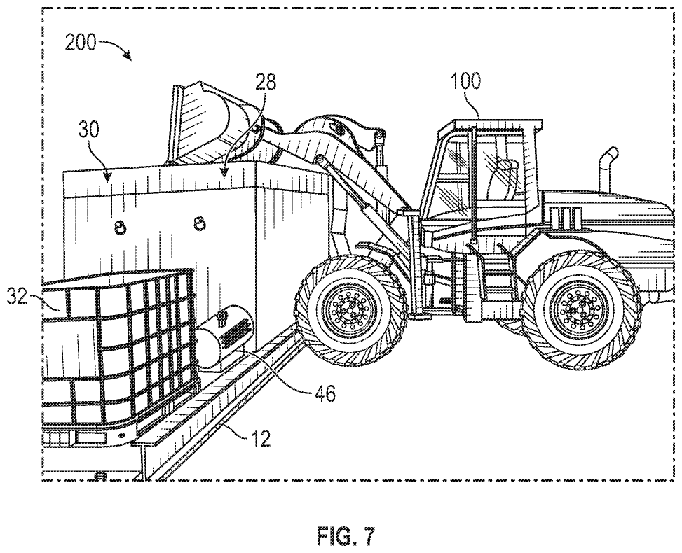

FIGS. 1, 4, 5, and 8 illustrate the water supply unit 400, which comprises a water tank 24 mounted on the third portable skid 16. The water tank 24 preferably has a capacity of at least 7,000 gallons and is preferably constructed from a recycled shipping container tank that is modified for use with the present system 10. The water tank 24 preferably has an open top rather than being an enclosed tank. The water supply unit 400 has a water pump 74 that supplies water from the water tank 24 to the concrete mixer 20 on the concrete mixing unit 200 through a water supply line 76. The water supply line 76 is preferably a flexible hose at least 40 feet in length to connect the water supply unit 400 to the concrete mixing unit 200, which may not be directly adjacent to each other. As shown in FIG. 1, the outlet of the water pump 74 and the water inlet at the concrete mixing unit 200 may have camlock connections 78, which are preferably four-inch camlock fittings, for connecting the water supply line 76 to supply water to the concrete mixer 20. As best seen in FIG. 8, the water supply unit 400 may have a water fill pipe 94 with an inlet connection 96 for connecting to a water source to fill the water tank 24 with water before or during cement production. Water may be sourced from a water truck, a municipal water supply, or any other suitable source of water. The water supply unit may optionally have a chiller and heater to provide the capability to change the water temperature without the addition of admixture chemicals and additionally to prevent the water from freezing in cold weather conditions.

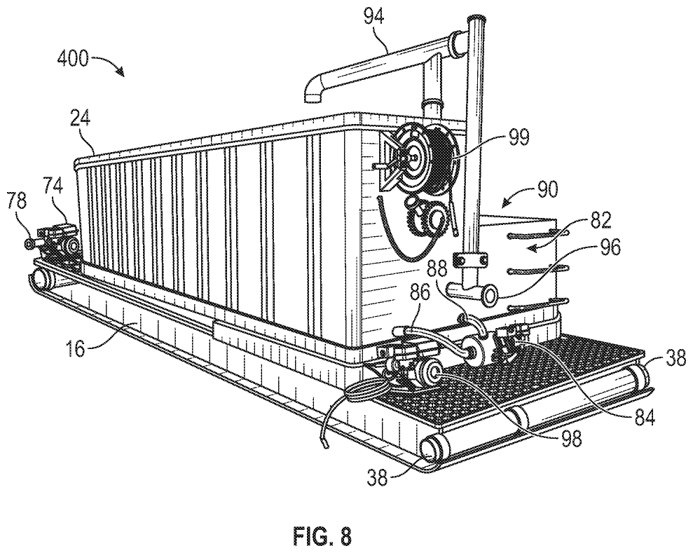

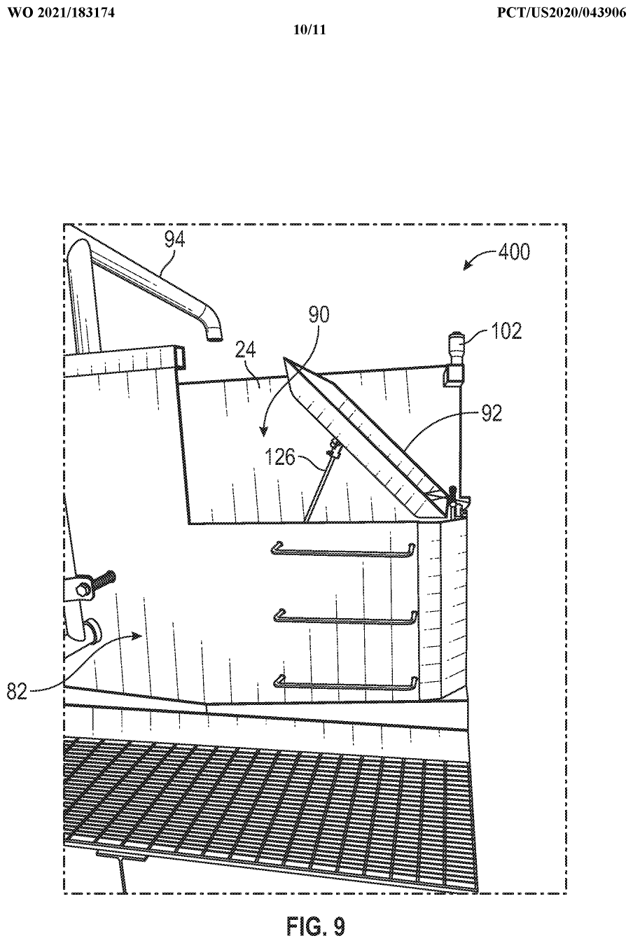

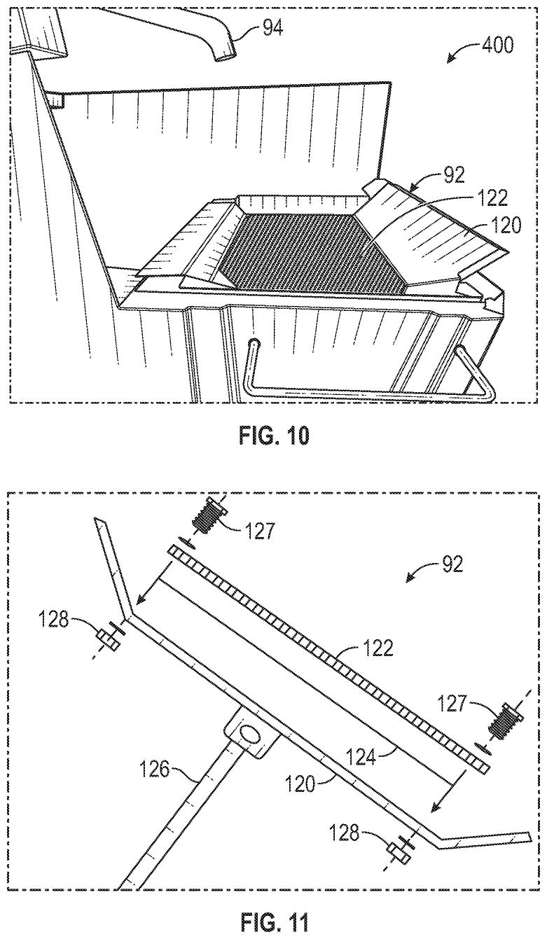

As best seen in FIGS. 9 and 10, the water supply unit 400 may optionally comprise a wet concrete slurry recycling system 90 configured for recycling any concrete slurry that may remain unused after completion of a job. The wet concrete recycling system 90 comprises an aggregate screen 92 positioned over a holding tank 82 and a recycle pump 84 configured to transfer recycled water from the holding tank 82 into the main water tank 24. As best seen in FIG. 9, the aggregate screen 92 may be tiltable upward from a horizontal position, preferably up to an angle of 70 degrees from the horizontal. As best seen in FIG. 11, the aggregate screen 92 is preferably an assembly comprising a screen holder 120, a gravel screen 122, and a sand screen 124. The assembly 92 may be assembled by using bolts 127 and nuts 128 to fasten the screen holder 120, the gravel screen 122, and the sand screen 124 together to form the assembly. The aggregate screen assembly 92 may additionally include a hydraulic arm 126 configured to tilt the screen 92 upward. As best seen in FIGS. 4 and 9, the holding tank 82 is preferably formed from part of the same shipping container tank as the main water tank 24, but has a section cut out so that the aggregate screen 92 may be positioned at a lower height than the top of the water tank 24 for ease of using the recycling system 90 for recycling concrete slurry.

To recycle concrete slurry in the wet concrete recycling system 90, unused concrete slurry is pumped over the aggregate screen 92 to filter aggregate out of the wet slurry and to collect recycled water from the slurry as the recycled water flows through the aggregate screen 92 and into the holding tank 82 below the screen. The gravel screen 122 has screen openings sized to filter out gravel and other larger aggregate. The sand screen 124 has smaller openings sized to filter out sand and other smaller aggregate. Before pumping the concrete slurry over the aggregate screen 92, the aggregate screen 92 is preferably tilted upward into an angled position as shown in FIG. 9. As the slurry is pumped over the aggregate screen 92, the aggregate may accumulate on the gravel screen 122 and then fall downward onto the ground adjacent to the recycling system 90. The recycled aggregate may then be collected from the ground and added back into the aggregate bins 28, 30 using the front-end loader 100. Alternatively, concrete slurry may be recycled with the aggregate screen 92 in the horizontal position, as shown in FIG. 10, and aggregate can be periodically removed from the screen 92 when build-up occurs. To pump the slurry over the aggregate screen 92, a concrete mixer truck holding the wet concrete slurry to be recycled may be parked adjacent to the recycling system 90. In order to allow access to the recycling system 90 by the mixer truck and front-end loader 100, the water supply unit 400 is preferably positioned so that another skid unit 200, 300 is not positioned adjacent to the recycling system 90, as shown in FIG. 1. Similarly, in order to provide access to the aggregate bins 28, 30 by the front-end loader 100, the concrete mixing unit 200 is preferably positioned so that one side of the unit 200 is accessible for loading aggregate. Thus, FIG. 1 shows the preferred configuration of the skid units 200, 300, and 400 with the power supply unit 300 positioned between the concrete mixing unit 200 and the water supply unit 400.

After filtering out the aggregate, the recycled water in the holding tank 82 may then be transferred into the water tank 24 using the recycle pump 84, which is preferably mounted on the third portable skid 16, as shown in FIG. 8. The recycle pump 84 has an inlet line 86 connected to the holding tank 82 and an outlet line 88 connected to the main water tank 24 for transferring recycled water. After filtering out aggregate, the recycled water generally still contains cement from the concrete slurry. The cement becomes diluted once the recycled water is transferred into the main water tank 24 and may be incorporated into subsequent concrete production through the addition of water from the main tank 24 that includes recycled water.

The water supply unit 400 may optionally include a pressure washer 98 with a hose 99, which may be mounted on the third portable skid 16, as shown in FIG. 8. The pressure washer 98 may be used for washing down the cement mixer truck after use or after recycling unused cement slurry, or for washing down the holding tank 82 or any other equipment in the system 10.

As shown in FIG. 1, the system 10 also includes a portable cement silo 18. The cement silo 18 is preferably a “cement pig” having a horizontal silo mounted on a truck or on a trailer that may be towed by a truck for transportation to the construction site. The cement silo 18 preferably has a cement capacity sufficient to provide cement for at least a full day of operation of the system 10. A blower 56 is preferably pre-installed on the truck or trailer for conveying cement from the cement silo 18 to the concrete mixing unit 200 through a cement supply line 58. The blower 56 preferably includes a 30-horsepower blower motor. The exterior of the cement bin 34 and the outlet of the blower 58 may have camlock connections 60 for connecting the cement supply line 58 to the blower 56 and to the cement bin 34 to supply cement to the concrete mixer 20. The cement supply line 58 is preferably a flexible line having a six-inch diameter. The blower 56 may be activated by a control sensor that measures the weight of the cement in the cement bin 34 on the concrete mixing unit 200 to automatically transfer cement into the cement bin 34 in order to ensure a continuous supply of cement to the concrete mixer 20.

To set up the concrete production system 10 on a job site, each of the skid units 200, 300, 400 are transported to the site. Each may be transported individually by cargo truck. Each skid unit 200, 300, 400 may be loaded onto and unloaded off of a truck by winch or by a small crane. The portable cement silo 18 may be transported individually to the job site and may optionally be transported separately by a third-party cement provider contracted to provide cement. The skid units 200, 300, 400 and cement silo 18 are unloaded on-site and placed in close proximity to each other, preferably in the configuration shown in FIG. 1. In this configuration, the system 10 generally requires no more than approximately 5,000 to 8,000 square feet of space, including space for aggregate stockpiles to be loaded into the aggregate bins 28, 30 on the concrete mixing unit 200.

Once the individual skid units 200, 300, 400 and cement silo 18 are set in place, the units may then be operatively connected to each other. The power supply unit 300 is operatively connected to the concrete mixing unit 200, to the water supply unit 400, and to the portable cement silo 18 with electrical power lines 62, 72, 80 so that the generator 27 supplies power to the various components of the concrete mixing unit 200, the water supply unit 400, and the portable cement silo 18 that require electrical power. To power the water pump 74 on the water supply unit 400 that supplies water to the concrete mixer 20, an electrical power line 80 is connected to the generator 27 and to the water pump 74. To power the cement blower 56 on the cement silo 18 that supplies cement to the cement bin 34, another electrical power line 62 is connected to the generator 27 and to the blower 56. To power the electric motor 46, the admixture pump 33, and other equipment on the concrete mixing unit 200 that require electrical power, a separate electrical power line 72 is connected between the generator 27 and the concrete mixing unit 200. As shown in FIG. 1, the concrete mixing unit 200 is preferably configured such that a single power line 72 may be connected to a single connection on the concrete mixing unit 200 to power all equipment on the concrete mixing unit 200. To this end, separate electrical lines may be pre-installed on the concrete mixing unit 200 between each respective piece of equipment requiring electrical power and the connection for the electrical power line 72 on the concrete mixing unit 200.

Next, the concrete mixing unit 200 is operatively connected to both the water supply unit 400 and to the cement silo 18, as shown in FIG. 1. To connect these units, a water supply line 76 is operatively connected to the water tank 24 of the water supply unit 400 and to the concrete mixer 20 of the concrete mixing unit 200, preferably using camlock connections 78. Once connected, the water pump 74 may be used to supply water from the water tank 24 to the concrete mixer 20. In addition, a cement supply line 58 is operatively connected to the portable cement silo 18 and to the concrete mixer 20 of the concrete mixing unit 200, preferably using camlock connections 60. The cement line 58 is preferably connected directly to the cement bin 34, and the dry cement auger 70 is then used to input the cement directly into the mixer 20. Once connected, the cement blower 56 may be used to supply cement from the cement silo 18 to the concrete mixer 20. The concrete slurry discharge auger 22 may then be attached to the concrete mixing unit 200. In addition, the optional conveyor 42 system, as shown in FIG. 2, may be set up for use to discharge cement slurry into a concrete mixer truck.

Once all of these connections between units are complete, the system 10 is ready for on-site concrete production. Thus, all of the skid units 200, 300, 400 and the cement silo 18 may be operatively connected to each other through electrical power connections 62, 72, 80 and supply lines 58, 76 for conveying cement and water into the concrete mixer 20. No major operational components of the system 10 need to be separately moved or assembled on-site. The final step for set up of the system 10 is to ensure that the water tank 24 contains water, the aggregate bins 28, 30 contains aggregate, and the admixture tanks 32 are connected and contain any appropriate admixture chemicals needed for concrete production.

Once all of the skid units 200, 300, 400 and cement silo 18 are set up and operatively connected, cement production may begin by supplying water from the water tank 24, cement from the cement silo 18, and aggregate from the aggregate bins 28, 30 into the concrete mixer 20. These raw materials may be input into the mixer 20 by the water pump 74, the blower 56, which is preferably used in conjunction with the dry cement auger 70, and the aggregate conveyor 48, respectively. Admixture chemicals may optionally be input into the concrete mixer 20 from one or more admixture tanks 32 using the admixture pump 33 along with the water, cement, and aggregate. These individual raw materials may be continuously added into the concrete mixer 20 where they are continuously and homogenously mixed to form a wet concrete slurry. The concrete mixer 20 may have a relatively small mixing area, which may best be seen in FIG. 2, into which the ingredients for the concrete are input. The auger 22 may extend into the mixing area of the mixer 20 and mix the ingredients through the rotating action of the auger 22 to form a homogenous slurry mixture. As the raw materials are continuously input into the mixer 20, the homogenous wet concrete slurry may then be continuously conveyed by the auger 22 to a discharge point 15 so that concrete slurry may be produced continuously rather than in batches. The rate of discharge may be controlled by adjusting the speed of rotation of the auger 22.

As shown in FIG. 2, the auger 22 may be used to discharge the concrete slurry onto a conveyor belt 42, which may be used to transfer the concrete slurry into a concrete mixer truck used to pour the concrete for final placement. The mixer truck may have a drum mixer to continuously mix the concrete slurry, but the concrete slurry is already well-mixed when discharged so a drum mixer may not be required if pouring the concrete slurry immediately at a nearby on-site location. In other embodiments, the concrete slurry may be discharged directly to a concrete pump used for pouring and setting the concrete, depending on the proximity of the final placement location to the discharge point 15.

The system 10 may be operated by two operators. One operator will generally be stationed in the main control room 36 to constantly monitor the operation and make any adjustments as needed. The operator may control concrete production by the system 10 using the control panel 52 of the control system 50. A second operator may operate a front-end loader 100 to load aggregate, such as sand or gravel, into the aggregate bins 28 and 30 in order to maintain a continuous supply of aggregate into the concrete mixer 20. The second operator may use the second control panel 54 on the concrete mixing unit 200 to directly control the concrete mixer 20. Once set up, the system 10 may produce up to 80 cubic yards of high-quality concrete per hour. The present system 10 provides concrete loads that have consistent physical properties, thereby providing for improved compressive strength and integrity of the concrete mix compared to other mobile concrete plants due to consistent homogenous mixing of the raw materials using the present concrete mixer 20. The present system 10 may also provide for a faster set up time and thus a quicker start-up compared to other mobile concrete plants, thereby providing cost savings. The present system 10 may also provide environmental benefits because the system preferably utilizes recycled shipping containers (for the power supply unit 300) and recycled shipping container tanks (for the water supply unit 400). Additionally, the present system 10 does not require settling ponds and generally also does not require height permits because the individual units 200, 300, 400 are constructed within legal height limits, as well as within load limits for road transport.

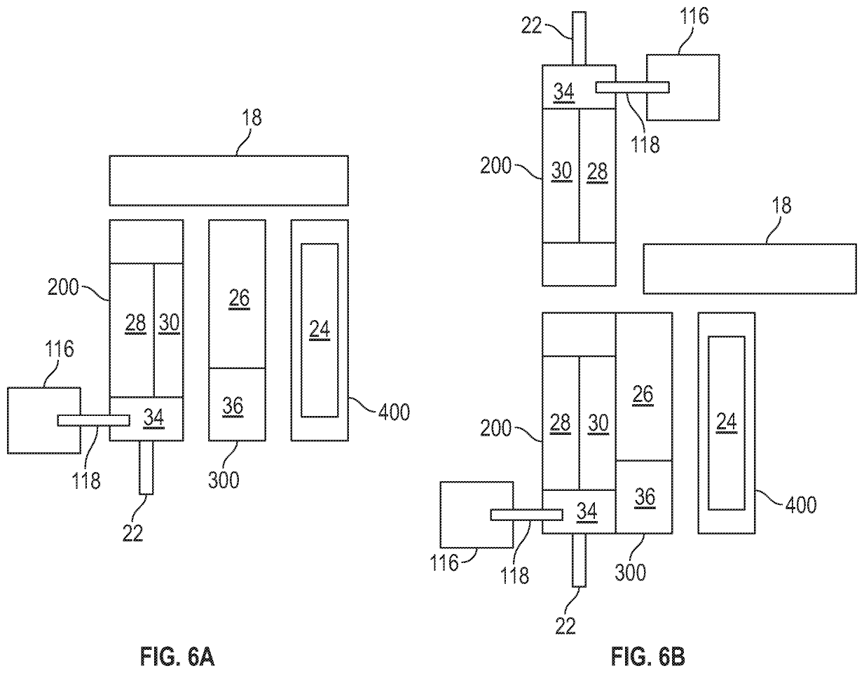

Optionally, as shown in FIG. 6A, the concrete production system 10 may include a second cement silo 116 and a second auger 118 that conveys cement from the second cement silo 116 to the concrete mixer 20. In this configuration, the cement supply line 58 may be operatively connected to the portable cement silo 18 and to the concrete mixer 20 by connecting the cement supply line 58 directly to the second cement silo 116 and then using the second auger 118 to transfer cement from the second cement silo 116 to the concrete mixer 20, preferably by conveying the cement from the second cement silo 116 directly into the cement bin 34. The second cement silo 116 is preferably a portable low-profile silo that can be positioned adjacent to the cement bin 34 of the concrete mixing unit 200. The second cement silo 116 may provide additional cement capacity when replacing the main cement silo 18 with a new, replenished cement silo 18 during concrete production.

FIGS. 6B and 6C illustrate optional configurations of the system 10 for providing increased concrete production compared to the basic configuration shown in FIGS. 1 and 6A. FIG. 6B shows a configuration utilizing two concrete mixing units 200 for doubling concrete production. This configuration may be operated with only one water supply unit 400, one power supply unit 300, and one cement silo 18. FIG. 6C shows a configuration utilizing three concrete mixing units 200 for tripling concrete production. In this configuration, the system 10 preferably includes two water supply units 300 and two cement silos 18 to accommodate the increase in concrete production, though only one power supply unit 300 is needed to supply electrical power to the system 10.

It is understood that versions of the present disclosure may come in different forms and embodiments. Additionally, it is understood that one of skill in the art would appreciate these various forms and embodiments as falling within the scope of the invention as disclosed herein.

1. A portable skid-mounted concrete production system, comprising:
a concrete mixing unit mounted on a first portable skid, wherein the concrete mixing unit comprises a concrete mixer having inputs for water, cement, and aggregate and an auger that conveys concrete slurry from the concrete mixer;
a power supply unit mounted on a second portable skid, wherein the power supply unit comprises a generator;
a water supply unit comprising a water tank mounted on a third portable skid; and
a portable cement silo,
wherein the power supply unit is operatively connected to the concrete mixing unit, to the water supply unit, and to the portable cement silo such that the generator supplies power to the concrete mixing unit, to the water supply unit, and to the portable cement silo,
wherein the system further comprises a water supply line connecting the water tank of the water supply unit to the concrete mixer of the concrete mixing unit for supplying water to the concrete mixer, and
wherein the system further comprises a cement supply line connecting the cement silo to the concrete mixer of the concrete mixing unit for supplying cement to the concrete mixer.

2. The skid-mounted concrete production system of claim 1, wherein each portable skid comprises a generally flat transport structure configured for mounting components of the concrete production system on the transport structure.

3. The skid-mounted concrete production system of claim 1, wherein each portable skid comprises a plurality of attachment points each configured for securing a cable to the skid for loading and unloading the skid onto and off of a transportation vehicle.

4. The skid-mounted concrete production system of claim 1, wherein the water supply unit comprises a wet concrete recycling system configured for recycling concrete slurry, wherein the wet concrete recycling system comprises an aggregate screen positioned over a holding tank and a recycle pump configured to transfer recycled water from the holding tank into the water tank.

5. The skid-mounted concrete production system of claim 4, wherein the aggregate screen is tiltable upward from a horizontal position.

6. The skid-mounted concrete production system of claim 1, wherein the water tank of the water supply unit comprises a shipping container tank.

7. The skid-mounted concrete production system of claim 1, wherein the power supply unit further comprises a control room, and wherein the control room and the generator are disposed within a shipping container.

8. The skid-mounted concrete production system of claim 1, wherein the system further comprises an admixture tank and an admixture pump configured to transfer an admixture chemical from the admixture tank into the concrete mixer.

9. The skid-mounted concrete production system of claim 1, wherein the concrete mixing unit comprises an aggregate bin mounted on the first portable skid and a conveyor configured to input aggregate from the aggregate bin into the concrete mixer.

10. The skid-mounted concrete production system of claim 1, wherein the system further comprises a second cement silo and a second auger that conveys cement from the second cement silo to the concrete mixer.

11. A method of producing concrete, said method comprising the steps of:
providing a portable skid-mounted concrete production system, comprising:
a concrete mixing unit mounted on a first portable skid, wherein the concrete mixing unit comprises a concrete mixer having inputs for water, cement, and aggregate and an auger that conveys concrete slurry from the concrete mixer,
a power supply unit mounted on a second portable skid, wherein the power supply unit comprises a generator,
a water supply unit comprising a water tank mounted on a third portable skid, and
a portable cement silo;
operatively connecting the power supply unit to the concrete mixing unit, to the water supply unit, and to the portable cement silo such that the generator supplies power to the concrete mixing unit, to the water supply unit, and to the portable cement silo;
operatively connecting a water supply line to the water tank of the water supply unit and to the concrete mixer of the concrete mixing unit such that the water tank supplies water to the concrete mixer;
operatively connecting a cement supply line to the portable cement silo and to the concrete mixer of the concrete mixing unit such that the cement silo supplies cement to the concrete mixer;
supplying water from the water tank, cement from the cement silo, and aggregate into the concrete mixer;
continuously mixing the water, cement, and aggregate in the concrete mixer to form concrete slurry; and
conveying the concrete slurry from the concrete mixer to a discharge point using the auger.

12. The method of claim 11, wherein each portable skid comprises a generally flat transport structure configured for mounting components of the concrete production system on the transport structure.

13. The method of claim 11, wherein each portable skid comprises a plurality of attachment points each configured for securing a cable to the skid for loading and unloading the skid onto and off of a transportation vehicle.

14. The method of claim 11, wherein the water supply unit comprises a wet concrete recycling system configured for recycling concrete slurry, wherein the wet concrete recycling system comprises an aggregate screen positioned over a holding tank and a recycle pump configured to transfer recycled water from the holding tank into the water tank, wherein the method further comprises the step of recycling unused concrete slurry by pumping the unused concrete slurry over the aggregate screen to filter aggregate out of the unused concrete slurry and collect recycled water from the unused concrete slurry in the holding tank and then transferring the recycled water from the holding tank into the water tank.

15. The method of claim 14, wherein the aggregate screen is tiltable upward from a horizontal position, wherein the step of recycling unused concrete slurry further comprises tilting the aggregate screen upward before pumping the unused concrete slurry over the aggregate screen.

16. The method of claim 11, wherein the water tank of the water supply unit comprises a shipping container tank.

17. The method of claim 11, wherein the power supply unit further comprises a control room, and wherein the control room and the generator are disposed within a shipping container.

18. The method of claim 11, wherein the system further comprises an admixture tank and an admixture pump configured to transfer an admixture chemical from the admixture tank into the concrete mixer, wherein the method further comprises the step of transferring the admixture chemical from the admixture tank into the concrete mixer with the water, cement, and aggregate.

19. The method of claim 11, wherein the concrete mixing unit comprises an aggregate bin mounted on the first portable skid and a conveyor configured to input aggregate from the aggregate bin into the concrete mixer, wherein the step of supplying aggregate into the concrete mixer comprises using the conveyor to supply aggregate from the aggregate bin into the concrete mixer.

20. The method of claim 11, wherein the system further comprises a second cement silo and a second auger that conveys cement from the second cement silo to the concrete mixer, wherein the step of operatively connecting a cement supply line to the portable cement silo and to the concrete mixer comprises connecting the cement supply line to the second cement silo and using the second auger to transfer cement from the second cement silo to the concrete mixer.
